(19) United States
(12) Patent Application Publication
(10) Pub. No.: US 2019/0322497 A1
(43) Pub. Date: Oct. 24, 2019

(54) HYDRAULIC CYLINDER, HYDRAULIC SYSTEM, AND CRANE

(71) Applicant: Xuzhou Heavy Machinery Co., Ltd., Xuzhou City, Jiangsu (CN)

(72) Inventors: Zenghai Shan, Xuzhou City (CN); Shouwei Wang, Xuzhou City (CN); Yinmei Ren, Xuzhou City (CN); Dong Wang, Xuzhou City (CN); Houbao Qi, Xuzhou City (CN)

(73) Assignee: Xuzhou Heavy Machinery Co., Ltd., Xuzhou City, Jiangsu (CN)

(21) Appl. No.: 16/474,845

(22) PCT Filed: Dec. 30, 2016
(86) PCT No.: PCT/CN2016/113337

§ 371 Date: Jun. 28, 2019

(51) Int. Cl. B66C 23/00; F15B 15/02

(52) U.S. Cl. CPC B66C 23/54; B66C 2700/0392; F15B 15/02

(57) ABSTRACT

The present disclosure relates to a hydraulic cylinder, a hydraulic system and a crane. The hydraulic cylinder comprises: a cylinder body; a first piston disposed in the cylinder body and capable of moving along an axial direction of the cylinder body; and a piston rod with one end connected on the first piston and extending along the axial direction of the cylinder body, wherein the cylinder body has a first cavity positioned on one side of the first piston facing away from the piston rod, the first cavity is capable of introducing and discharging hydraulic fluid, the piston rod has a second cavity extending along the axial direction of the cylinder body; and the hydraulic cylinder further comprises a second piston capable of moving along the second cavity, the second piston is fixed relative to the cylinder body, the second cavity comprises an accommodating cavity positioned on one side of the second piston facing the first piston, when the first cavity introduces the hydraulic fluid, the accommodating cavity can discharge the hydraulic fluid, and when the first cavity discharges the hydraulic fluid, the accommodating cavity can introduce the hydraulic fluid. The technical solution of the present application improves the problem that the amount of change of the hydraulic fluid in the hydraulic cylinder is large in the moving process of the piston rod in the related art.

### FIELD OF THE INVENTION

The present disclosure relates to the field of engineering equipment, in particular to a hydraulic cylinder, a hydraulic system and a crane.

### BACKGROUND OF THE INVENTION

FIG. 1 is a structural schematic diagram of a hydraulic cylinder of the related art. As shown in FIG. 1, the hydraulic cylinder comprises a cylinder body 1′, a piston 2′ which is disposed in the cylinder body 1′ and capable of moving along an axial direction of the cylinder body 1′, and a piston rod connected on the piston 2′. The cylinder body 1′ has a first cavity 4′ positioned on one side of the piston 2′ facing away from the piston rod 3′, and a second cavity 5′ positioned on one side of the piston 2′ facing the piston rod 3′. The first cavity 4′ and the second cavity 5′ can introduce and discharge hydraulic fluid.

In the related art, a hydraulic system comprises the hydraulic cylinder, a box body for accommodating the hydraulic fluid and a pump for pressurizing the hydraulic fluid in the box body. Both the first cavity 4′ and the second cavity 5′ can be communicated with the pump, and both the first cavity 4′ and the second cavity 5′ can be communicated with the box body.

When the first cavity 4′ is communicated with the pump to introduce the hydraulic fluid pressurized by the pump, the second cavity 5′ discharges the hydraulic fluid therein into the box body, and the piston rod 3′ extends out of the cylinder body 1′; and when the second cavity 5′ is communicated with the pump to introduce the hydraulic fluid pressurized by the pump, the first cavity 4′ discharges the hydraulic fluid therein into the box body, and the piston rod 3′ retracts into the cylinder body 1′.

As shown in FIG. 1, the inner diameter of the first cavity 4′ and the inner diameter of the cylinder body 1′ are D respectively, the area S1 of the section of the first cavity 4′ which is perpendicular to the axial direction of the cylinder body 1′ is as follows: S1=πD²/4, and in the process that the piston 2′ moves a unit distance 1 along the axial direction of the cylinder body 1′, the volume v₁ of the hydraulic fluid introduced or discharged by the first cavity 4′ is as follows: v₁=1 S1=lπ(D²/4.

The outer diameter of the piston rod 3′ is d, the area S₂ of the section of the second cavity 5′ which is perpendicular to the axial direction of the cylinder body 1′ is as follows: S₂=π((D²−d²)/4, and in the process that the piston 2′ moves the unit distance 1 along the axial direction of the cylinder body 1′, the volume v₂ of the hydraulic fluid introduced or discharged by the second cavity 5′ is as follows: v₂=l S₂=lπ((D²−d²)/4. Preferably, the piston rod 3′ is tubular, and the inner diameter of the piston 3′ is d₁.

In the process that the piston 3′ moves the unit distance 1 along the axial direction of the cylinder body 1′, the amount of change v₃ of the hydraulic fluid in the hydraulic cylinder (including the hydraulic fluid in the first cavity 4′ and the hydraulic fluid in the second cavity 5′) is as follows: v₃=v₁−v₂=lπd²/4.

The maximum distance of the movement of the piston 2′ along the axial direction of the cylinder body 1′ is L. When the piston rod 3′ moves the distance L, the amount of change V₃ of the fluid in the hydraulic cylinder is as follows: V₃=v₃L=Lπd²/4, and the corresponding amount of change of the hydraulic fluid in the box body is equal to V₃, so that the minimum volume of the box body is V₃.

Thus, the larger the outer diameter of the piston rod 3′, the larger the amount of change of the hydraulic fluid in the hydraulic cylinder in the process that the piston 3′ moves in the cylinder body 1′, and the larger the volume of the box body required for the corresponding hydraulic cylinder.

As the requirement of various engineering equipment for the driving capacity of the hydraulic cylinder is increased, the size of the hydraulic cylinder is continuously increased, and the outer diameter d of the piston rod 3′ of the hydraulic cylinder also needs to be increased correspondingly, so it is necessary to equip a larger box body for the hydraulic cylinder to accommodate the hydraulic fluid.

### SUMMARY OF THE INVENTION

The present disclosure aims at providing a hydraulic cylinder, a hydraulic system and a crane to improve the problem that the amount of change of hydraulic fluid in the hydraulic cylinder is large in the moving process of a piston in the related art.

According to one aspect of an embodiment, the present disclosure provides a hydraulic cylinder, comprising:

a cylinder body;

a first piston disposed in the cylinder body and being movable along an axial direction of the cylinder body;

a piston rod with one end connected on the first piston and extending along the axial direction of the cylinder body,

wherein the cylinder body has a first cavity for introducing and discharging hydraulic fluid, the first cavity is positioned on one side of the first piston facing away from the piston rod,

the piston rod has a second cavity extending along the axial direction of the cylinder body, the hydraulic cylinder further comprises a second piston that is movable along the second cavity, the second piston is fixed relative to the cylinder body, the second cavity comprises an accommodating cavity positioned on one side of the second piston facing the first piston, when the first cavity introduces the hydraulic fluid, the accommodating cavity can discharge the hydraulic fluid, and when the first cavity discharges the hydraulic fluid, the accommodating cavity can introduce the hydraulic fluid.

Optionally, the hydraulic cylinder further comprises a connecting unit for fixing the second piston relative to the cylinder body, wherein the connecting unit is connected with the second piston and extends to the first piston, a first through hole for allowing the connecting unit to pass through is formed in the first piston, and the connecting unit passes through the first through hole and is connected with the the cavity wall of the first cavity.

Optionally, the connecting unit comprises a tubular piece, one end of the tubular piece near to the second piston is communicated with the accommodating cavity, one end of the tubular piece away from the second piston is used for inputting the hydraulic fluid into the accommodating cavity and discharging the hydraulic fluid in the accommodating cavity.

Optionally, a first channel for communicating the accommodating cavity with the tubular piece is arranged on the second piston.

Optionally, a first hole communicated with the end of the tubular piece away from the second piston is formed in the the cavity wall of the first cavity, and the first hole is used for inputting the hydraulic fluid into the accommodating cavity and discharging the hydraulic fluid in the accommodating cavity.

Optionally, the cylinder body has a third cavity formed between the first piston rod and the cylinder body, the third cavity is communicated with the end of the tubular piece away from the second piston, the third cavity can introduce and discharge the hydraulic fluid, when the third cavity introduces the hydraulic fluid to push the piston rod to retract into the cylinder body, the first cavity discharges the fluid, and when the first cavity introduces the hydraulic fluid to push the piston rod to extend out of the cylinder body, the third cavity discharges the hydraulic fluid.

Optionally, the cylinder body has a third cavity formed between the piston rod and the cylinder body, the third cavity can introduce and discharge the hydraulic fluid, when the third cavity introduces the hydraulic fluid to push the piston rod to retract into the cylinder body, the first cavity discharges the fluid, and when the first cavity introduces the hydraulic fluid to push the piston rod to extend out of the cylinder body, the third cavity discharges the hydraulic fluid.

Optionally, the third cavity is communicated with the accommodating cavity.

Optionally, a second hole for communicating the third cavity with the accommodating cavity is formed in the piston rod.

Optionally, a second channel for communicating the accommodating cavity with the third cavity is arranged on the first piston.

Optionally, the accommodating cavity is communicated with the first cavity.

Optionally, a second through hole for communicating the first cavity with the accommodating cavity is formed in the first piston.

According to another aspect of an embodiment, the present application further provides a hydraulic system, and the hydraulic system comprises:

the above hydraulic cylinder;

a box body for accommodating the hydraulic fluid discharged by the accommodating cavity and/or the first cavity; and

a pump for pressurizing the hydraulic fluid in the box body and capable of delivering the pressurized hydraulic fluid to the first cavity to push the first piston to move.

Optionally, the hydraulic system has a first working state and a second working state,

in the first working state, the first cavity and the pump are communicated to introduce the hydraulic fluid pressurized by the pump, and the accommodating cavity and the box body are communicated to discharge the hydraulic fluid in the accommodating cavity into the box body; and

in the second working state, the first cavity and the box body are communicated to discharge the hydraulic fluid in the first cavity into the box body, and the accommodating cavity and the box body are communicated to introduce the hydraulic fluid pressurized by the pump.

According to still another aspect of an embodiment, the present application further provides a crane, optionally comprising the above hydraulic system.

Optionally, the crane further comprises a boom, and the hydraulic cylinder is used for driving the bottom to rotate.

By applying the technical solution of the present application, the piston rod has the accommodating cavity capable of accommodating the hydraulic fluid. When the first cavity introduces the hydraulic fluid to push the piston rod to extend out of the cylinder body, the accommodating cavity can discharge the hydraulic fluid, and the amount of increase of the hydraulic fluid in the hydraulic cylinder reduces the amount of the hydraulic fluid discharged by the accommodating cavity relative to the related art.

When the piston rod retracts into the cylinder body to enable the first cavity to discharge the hydraulic fluid, the accommodating cavity can introduce the hydraulic fluid, and the amount of decrease of the hydraulic fluid in the hydraulic cylinder reduces the amount of the hydraulic fluid introduced by the accommodating cavity relative to the related art.

Thus, the hydraulic cylinder in this embodiment improves the problem that the amount of change of the hydraulic fluid in the hydraulic cylinder is large in the moving process of the piston rod in the related art.

### BRIEF DESCRIPTION OF THE ACCOMPANYING DRAWINGS

The drawings illustrated here are for providing further understanding of the present application and thus constitute part of the present application. The exemplary embodiments of the present application and depictions thereof are for interpreting the present application, not constituting improper limitations of the present application. In the drawings:

FIG. 1 is a structural schematic diagram of a hydraulic cylinder of the related art;

FIG. 2 is a structural schematic diagram of the hydraulic cylinder of a first embodiment of the present disclosure;

FIG. 3 is a structural schematic diagram of the hydraulic system of the first embodiment of the present disclosure;

FIG. 4 is a structural schematic diagram of the hydraulic cylinder of a second embodiment of the present disclosure;

FIG. 5 is a structural schematic diagram of another preferred implementation way of the hydraulic cylinder of the second embodiment of the present disclosure;

FIG. 6 is a structural schematic diagram of another preferred implementation way of the hydraulic cylinder of the second embodiment of the present disclosure;

FIG. 7 is a structural schematic diagram of the hydraulic cylinder of a third embodiment of the present disclosure; and

FIG. 8 is a structural schematic diagram of another preferred implementation way of the hydraulic cylinder of the third embodiment of the present disclosure.

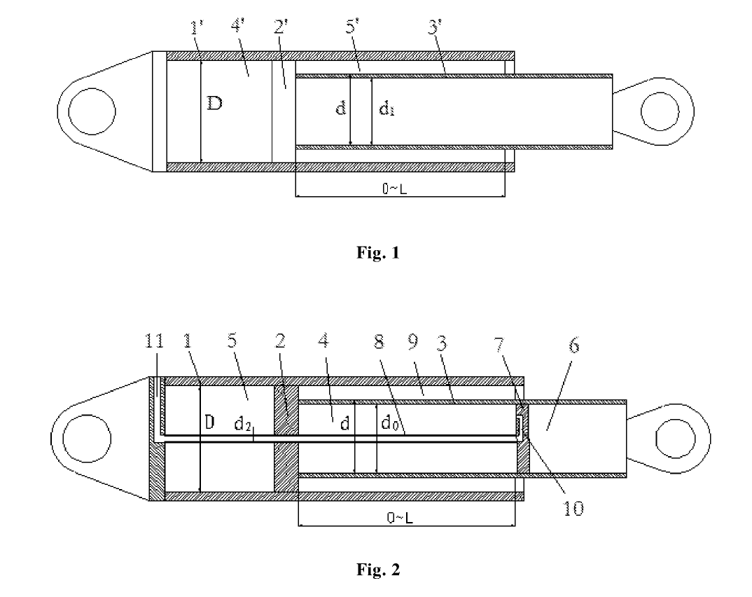

In the drawings: 1′, cylinder body; 2′, piston; 3′, piston rod; 4′, first cavity; 5′, second cavity; 1, cylinder body; 2, first piston; 3, piston rod; 4, accommodating cavity; 5, first cavity; 6, second cavity; 7, second piston; 8, connecting unit; 9, third cavity; 10, first channel; 11, first hole; 12, second through hole; 13, second channel; 14, pipeline; 15, second through hole; 30, hydraulic cylinder; 40, box body; 50, pump; and 60, reversing valve.

### DETAILED DESCRIPTION OF THE PREFERRED EMBODIMENTS

The technical solutions of the present disclosure will be described in detail through the following drawings and embodiments.

The technical solutions in the embodiments of the present disclosure are clearly and completely described below with reference to the accompanying drawings in the embodiments of the present disclosure. Obviously, the described embodiments are only a part, but not all of the embodiments of the present disclosure. The following description of at least one exemplary embodiment is merely illustrative, and is in no way intended to limit the present disclosure and the application and the use thereof. Based on the embodiments in the present disclosure, all the other embodiments obtained by those of ordinary skill in the art without creative effort are still within the scope of the claimed present disclosure.

### Embodiment 1

FIG. 2 is a structural schematic diagram of a hydraulic cylinder of this embodiment. As shown in FIG. 2, the hydraulic cylinder of this embodiment comprises a cylinder body 1, a first piston 2 which is disposed in the cylinder body 1 and capable of moving along an axial direction of the cylinder body 1, and a piston rod 3 with one end connected on the first piston 2 and extending along the axial direction of the cylinder body 1.

The cylinder body 1 has a first cavity 5 positioned on one side of the first piston 2 facing away from the piston rod 3. The first cavity 5 can introduce hydraulic fluid to push the piston rod 3 to extend out of the cylinder body 1. In the process that the piston rod 3 retracts into the cylinder body 1, the first cavity 5 discharges the hydraulic fluid.

The piston rod 3 has an accommodating cavity 4 capable of accommodating the hydraulic fluid. When the first cavity 5 introduces the hydraulic fluid to push the piston rod 3 to extend out of the cylinder body 1, the accommodating cavity 4 can discharge the hydraulic fluid, and the amount of increase of the hydraulic fluid in the hydraulic cylinder reduces the amount of the hydraulic fluid discharged by the accommodating cavity 4 relative to the related art.

When the piston rod 3 retracts into the cylinder body 1 to enable the first cavity 5 to discharge the hydraulic fluid, the accommodating cavity 4 can introduce the hydraulic fluid, the amount of decrease of the hydraulic fluid in the hydraulic cylinder reduces the amount of the hydraulic fluid introduced by the accommodating cavity 4 relative to the related art.

Thus, the hydraulic cylinder in this embodiment improves the problem that the amount of change of the hydraulic fluid in the hydraulic cylinder is large in the moving process of the piston rod 3 in the related art.

The piston rod 3 has a second cavity 6 extending along the axial direction of the cylinder body 1, a second piston 7 capable of moving along the second cavity 6 is disposed in the second cavity 6, the second piston 7 is fixed relative to the cylinder body 1, and the accommodating cavity 4 comprises the part of the second cavity 6 positioned on one side of the second piston 7 facing the first piston 2.

When the first cavity 5 introduces the hydraulic fluid to push the piston rod 3 to extend out of the cylinder body 1, the distance between the first piston 2 and a second piston 7 is reduced, so that the volume of the accommodating cavity 4 is reduced, and the accommodating cavity 4 discharges the hydraulic fluid.

When the piston rod 3 retracts into the cylinder body 1 to enable the first cavity 5 to discharge the hydraulic fluid, the distance between the first piston 2 and the second piston 7 is increased, so that the volume of the accommodating cavity 4 is increased and the accommodating cavity 4 can introduce the hydraulic fluid.

In this embodiment, the accommodating cavity 4 is enclosed by the peripheral walls of the first piston 2, the second piston 7 and the second cavity 6.

The piston rod 3 extends from the first piston 2 to the first end of the cylinder body 1, and the second piston 7 is disposed at the first end of the cylinder body 1 to prevent the second piston 7 from hindering the movement of the first piston 2 along the axial direction of the cylinder body 1.

Optionally, the surface of the second piston 7 facing the first piston 2 is flush with the inner end surface of the first end of the cylinder body 1; and further preferably, the surface of the second piston 7 facing the first piston 2 is farther away from the first piston 2 than the inner end surface of the first end of the cylinder body 1.

An air vent is formed in the second cavity 6 which is positioned at the part of the second piston 7 facing away from the first piston 2 to enable the second piston 7 to smoothly move along the second cavity 6.

The hydraulic cylinder further comprises a connecting unit 8 for fixing the second piston 7 relative to the cylinder body 1, wherein the connecting unit 8 is connected with the second piston 7 and extends to the first piston 2, a first through hole for allowing the connecting unit 8 to pass through is formed in the first piston 2, and the connecting unit 8 passes through the first through hole and is connected with the cavity wall of the first cavity 5.

In this embodiment, the cavity wall of the first cavity 5 comprises the end wall of the cylinder body 1, and one end of the connecting unit 8 away from the second piston 7 is connected with the end wall of the cylinder body 1.

The connecting unit 8 comprises a tubular piece, one end of the tubular piece near to the second piston 7 is communicated with the accommodating cavity 4, one end of the tubular piece away from the second piston 7 is used for inputting the hydraulic fluid into the accommodating cavity 4 and discharging the hydraulic fluid in the accommodating cavity 4.

A first channel 10 for communicating the accommodating cavity 4 with the tubular piece is arranged on the second piston 7.

A first hole 11 communicated with the tubular piece is formed in the cavity wall of the first cavity 5. The first hole 11 extends from the outer surface of the cylinder body 1 into the end wall of the cylinder body 1, so as to communicate with the tubular piece.

When the first cavity 5 introduces the hydraulic fluid to push the piston rod 3 to extend out of the cylinder body 1, the hydraulic fluid discharged by the accommodating cavity 4 sequentially flows through the first channel 10, the tubular piece and the first hole 11.

When the piston rod 3 retracts into the cylinder body 1 to enable the first cavity 5 to discharge the hydraulic fluid, the hydraulic fluid introduced by the accommodating cavity 4 sequentially flows through the first hole 11, the first channel 10, the tubular piece and the first channel 10.

In this embodiment, the cylinder body 1 has a third cavity 9 positioned on one side of the first piston 2 facing the piston rod 3. The third cavity 9 can introduce and discharge the hydraulic fluid. As the piston rod 3 is positioned in the third cavity 9, the third cavity 9 is an annular space between the first piston 2 and the end wall of the cylinder body 1.

When the third cavity 9 introduces the hydraulic fluid to push the piston rod 3 to retract into the cylinder body 1, the distance between the first piston 2 and the second piston 7 is increased, the volume of the accommodating cavity 4 is increased, the accommodating cavity 4 introduces the hydraulic fluid, and the first cavity 5 discharges the hydraulic fluid at the same time.

When the first cavity 5 introduces the hydraulic fluid to push the piston rod 3 to extend out of the cylinder body 1, both the accommodating cavity 4 and the third cavity 9 discharge the hydraulic fluid.

In conjunction with FIG. 2, the inner diameter of the first cavity 5 and the inner diameter of the cylinder body 1 are D respectively, the outer diameter of the connecting unit 8 positioned in the first cavity 5 is d₂, and the amount of change v₁ of the hydraulic fluid in the first cavity 5 in the process that the piston rod 3 moves a unit distance 1 is as follows: v₁=l π(D²−d₂²).

The inner diameter of the third cavity 9 is equal to the diameter d of the piston rod 3, and the outer diameter of the third cavity 9 is equal to the inner diameter D of the cylinder body 1. In the process that the piston rod 3 moves the unit distance 1, the amount of change v₂ of the hydraulic fluid in the third cavity 9 is as follows: v₂=lπ(D²−d²).

The diameter of the accommodating cavity 4 is d₀, the outer diameter of the connecting unit 8 positioned in the accommodating cavity 4 is d₂, and in the process that the piston rod 3 moves the unit distance 1, the amount of change v3 of the hydraulic fluid in the first cavity 5 is as follows: v3=lπ((d₀²−d₂²).

The amount of change v₄ of the hydraulic fluid in the hydraulic cylinder (including the hydraulic fluid in the first cavity 5, the accommodating cavity 4 and the third cavity 9) is as follows: v₄=v₁−v₂−v₃=lπ((d²−d₀²).

Referring to FIG. 2, the maximum stroke of the piston rod 3 is L, so the maximum amount of change V of the hydraulic fluid in the hydraulic cylinder is as follows: V=Lπ(d²−d₀²), and the maximum amount of change of the hydraulic fluid in the hydraulic cylinder is the maximum amount of the hydraulic fluid introduced or discharged by the hydraulic cylinder.

In the case that the accommodating cavity 4 is not arranged on the piston rod 3, namely d₀ is 0, the maximum amount of change V0 of the hydraulic fluid in the hydraulic cylinder is as follows: V₀=Lπd².

It can be seen that since the accommodating cavity 4 with the diameter d₀ is disposed in the piston rod 3, the maximum amount of change of the hydraulic fluid in the hydraulic cylinder is reduced by V₁=V−V₀=Lπd₀². Thus, the closer the diameter of the accommodating cavity 4 to the diameter of the piston rod 3, the smaller the amount of change of the hydraulic fluid in the hydraulic cylinder in the moving process of the piston rod 3, namely the closer the amount of the hydraulic fluid introduced by the hydraulic cylinder to the amount of the discharged hydraulic fluid.

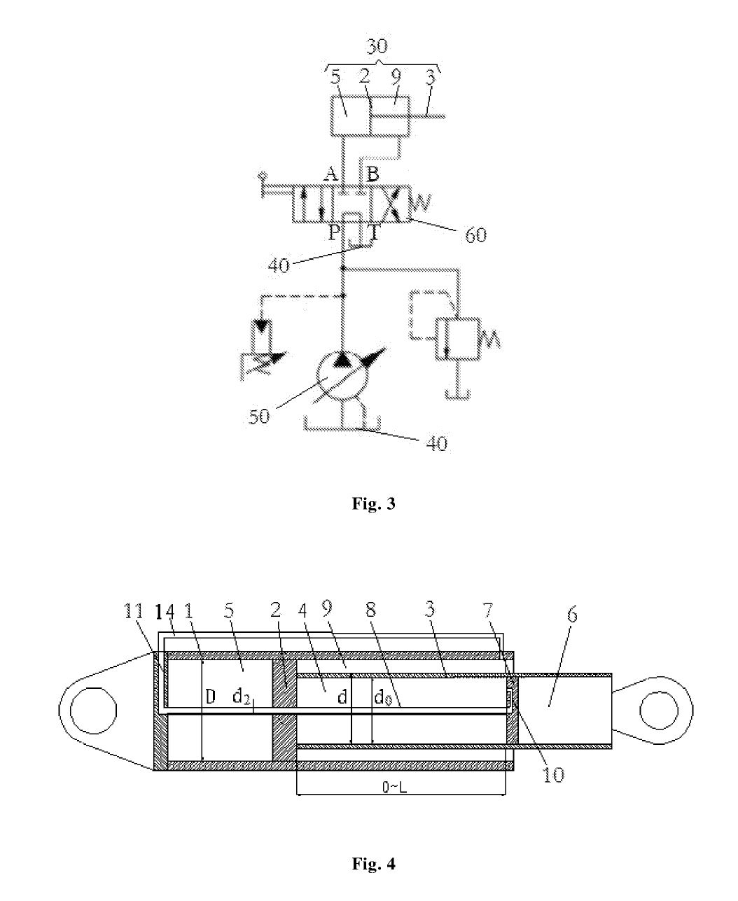

FIG. 3 is a structural schematic diagram of a hydraulic system of this embodiment. In conjunction with FIG. 2 and FIG. 3, the hydraulic system of this embodiment comprises the above hydraulic cylinder 30, a box body 40 for accommodating the hydraulic fluid and a pump 50 for pressurizing the hydraulic fluid in the box body 40.

The pump 50 can convey the pressurized hydraulic fluid to the first cavity 5 to push the piston rod 3 to extend out of the cylinder body 1. The pump 50 can also convey the pressurized fluid to the accommodating cavity 4 and the third cavity 9 to push the piston rod 3 to retract into the cylinder body 1.

The pressurized hydraulic fluid in the accommodating cavity 4 and the third cavity 9 can push the piston rod 3 to retract into the cylinder body 1, thereby increasing the driving force of the hydraulic cylinder.

As shown in FIG. 3, the hydraulic system of this embodiment further comprises a reversing valve 60, and the reversing valve 60 has a fluid inlet P, a backflow port T, a first working port A and a second working port B. The fluid inlet P is communicated with the pump 50, the backflow port T is communicated with the box body 40, the first working port A is communicated with the first cavity 5 of the hydraulic cylinder 30, and the second working port B is communicated with the third cavity 9 and the accommodating cavity 4 of the hydraulic cylinder 30.

In this embodiment, the second working port B is communicated with the first hole 11 in the hydraulic cylinder to realize the communication of the second working port and the accommodating cavity 4.

The reversing valve 60 comprises a first state and a second state. In the first state of the reversing valve 60, the first working port A is in conduction with the fluid inlet P, and the second working port B is in conduction with the backflow port T. The pump 50 enables the pressurized hydraulic fluid to enter into the first cavity 5 of the hydraulic cylinder 30 to push the piston rod 3 to extend out of the cylinder body 1 and discharges the hydraulic fluid in the third cavity 9 and the accommodating cavity 4 to the box body 40.

In the second state of the reversing valve 60, the first working port A is in conduction with the backflow port T, and the second working port B is in conduction with the fluid inlet P. The pump 50 enables the pressurized hydraulic fluid to respectively enter into the accommodating cavity 4 and the third cavity 9 to push the piston rod 3 to retract into the cylinder body 1, and discharges the hydraulic fluid discharged by the first cavity 5 to the box body 40.

According to another aspect of the present application, this embodiment further provides a crane, and the crane comprises the above hydraulic system. Optionally, the above hydraulic cylinder 30 of the hydraulic fluid is used for driving a boom of the crane to rotate.

### Embodiment 2

FIG. 4 is a structural schematic diagram of a hydraulic cylinder of this embodiment. As shown in FIG. 4, the hydraulic cylinder of this embodiment is different from the hydraulic cylinder of Embodiment 1 in that the hydraulic cylinder further comprises a pipeline 14 communicating the accommodating cavity 4 and the third cavity 9.

In this embodiment, the accommodating cavity 4 is communicated with the third cavity 9, when the first cavity 5 introduces the hydraulic fluid to push the piston rod 3 to extend out of the cylinder body 1, both the volume of the third cavity 9 and the volume of the accommodating cavity 4 are reduced, and both the third cavity 9 and the accommodating cavity 4 discharge the hydraulic fluid.

The accommodating cavity 4 and the third cavity 9 can also introduce the hydraulic fluid to push the piston rod 3 to retract into the cylinder body 1, the volume of the first cavity 5 is correspondingly reduced, and the first cavity 5 discharges the hydraulic fluid.

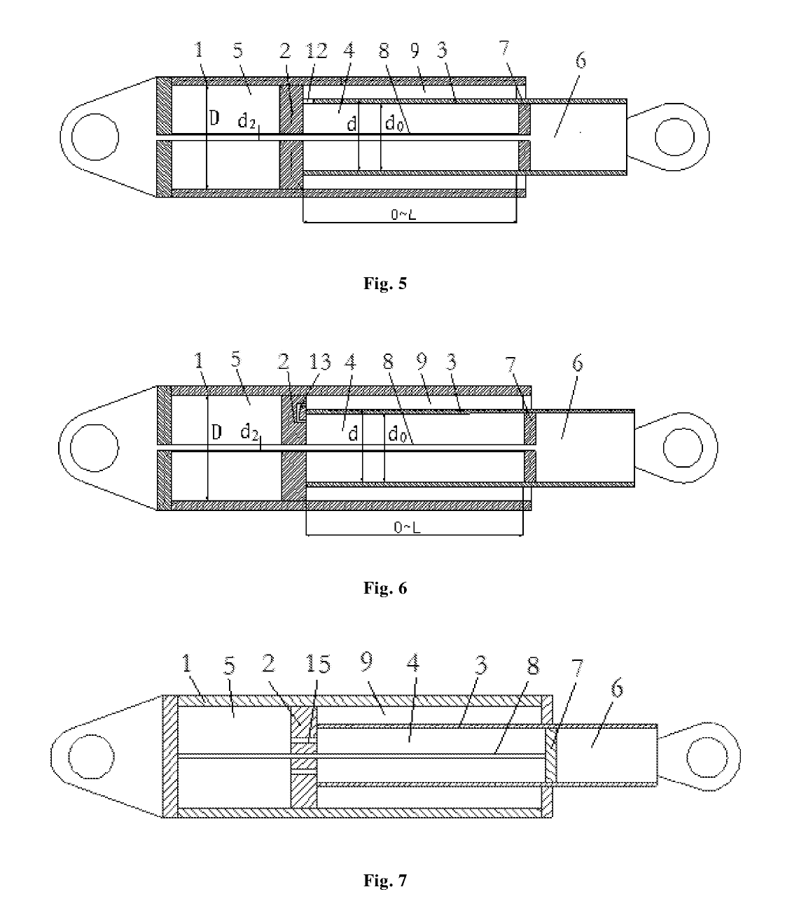

FIG. 5 is a structural schematic diagram of another implementation way of this embodiment. Referring to FIG. 5, a second hole 12 communicating the third cavity 9 and the accommodating cavity 4 is formed in the piston rod 3, thereby realizing the communication of the third cavity 9 and the accommodating cavity 4.

Optionally, the second hole 12 is positioned at one end of the piston rod 3 near to the first piston 2.

FIG. 6 is a structural schematic diagram of another implementation way of this embodiment. Referring to FIG. 6, a second channel 13 for communicating the accommodating cavity 4 with the third cavity 9 is arranged on the first piston 2.

### Embodiment 3

FIG. 7 is a structural schematic diagram of a hydraulic cylinder of this embodiment. Referring to FIG. 7, this embodiment is different from Embodiment 1 in that the accommodating cavity 4 is communicated with the first cavity 5.

In this embodiment, a second through hole 15 communicating the first cavity 5 and the accommodating cavity 4 is formed in the second piston 2. The accommodating cavity 4 is communicated with the first cavity 5, and not communicated with the third cavity 9.

Referring to FIG. 7, when the first cavity 5 introduces the hydraulic fluid to push the piston rod 3 to extend out of the cylinder body 1, the first piston 2 moves to the second piston 7, the volume of the accommodating cavity 4 is reduced, and the accommodating cavity 4 discharges the hydraulic fluid to the first cavity. Compared with the related art of not disposing the accommodating cavity 4 on the piston rod 3, the amount of the hydraulic fluid introduced by the first cavity 5 reduces the amount of the hydraulic fluid discharged by the accommodating cavity 4, and the amount of the hydraulic fluid discharged by the third cavity 9 is the same with that in the related art.

Thus, in the moving process of the piston rod 3, the amount of change of the hydraulic fluid in the hydraulic cylinder is reduced relative to the related art. Thus, the problem that the amount of change of the hydraulic fluid in the hydraulic cylinder is large in the moving process of the piston rod 3 in the related art is improved.

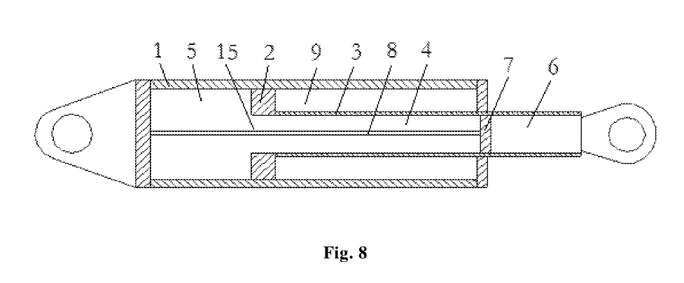

FIG. 8 is a structural schematic diagram of another preferred implementation way of this embodiment. As shown in FIG. 8, the connecting unit 8 is arranged in the second through hole 15 by penetration, a gap exists between the connecting unit 8 and the peripheral surface of the second through hole 15 to communicate the accommodating cavity 4 with the first cavity 5.

Finally, it should be noted that, the above embodiments are merely used for explaining the technical solutions of the present disclosure rather than limiting the present disclosure. Although the present disclosure is described in detail with reference to the preferred embodiments, those of ordinary skill in the art should understand that the specific embodiments of the present disclosure can still be modified or part of the technical features can be substituted equivalently without departing from the spirit of the technical solutions of the present disclosure, and such modifications and substitutions should fall within the protection scope of the technical solutions of the present disclosure.

1. A hydraulic cylinder, comprising:
a cylinder body;
a first piston disposed in the cylinder body and movable along an axial direction of the cylinder body;
a piston rod with one end connected on the first piston and extending along the axial direction of the cylinder body;
wherein the cylinder body has a first cavity for introducing and discharging hydraulic fluid, the first cavity is positioned on one side of the first piston far away from the piston rod;
wherein the piston rod has a second cavity extending along the axial direction of the cylinder body, the hydraulic cylinder further comprises a second piston that is movable along the second cavity, the second piston is fixed relative to the cylinder body;
the second cavity comprises an accommodating cavity positioned on one side of the second piston facing the first piston, the accommodating cavity is configured to discharge the hydraulic fluid when the first cavity introduces the hydraulic fluid, and introduce the hydraulic fluid when the first cavity discharges the hydraulic fluid,
the cylinder body has a third cavity for introducing and discharging hydraulic fluid, the third cavity is formed between the piston rod and the cylinder body and communicated with the accommodating cavity; and
the first cavity is configured to discharge the fluid when the third cavity introduces the hydraulic fluid to push the piston rod to retract into the cylinder body, and the third cavity is configured to discharge the hydraulic fluid when the first cavity introduces the hydraulic fluid to push the piston rod to extend out of the cylinder body.

2. The hydraulic cylinder according to claim 1, further comprising a connecting unit for fixing the second piston with respect to the cylinder body, wherein the connecting unit is connected with the second piston and extends to the first piston, a first through hole is formed in the first piston to allow the connecting unit to pass through, and the connecting unit passes through the first through hole and is connected with the cavity wall of the first cavity.

3. The hydraulic cylinder according to claim 2, wherein the connecting unit comprises a tubular piece, one end of the tubular piece adjacent to the second piston is communicated with the accommodating cavity, one end of the tubular piece away from the second piston is for inputting the hydraulic fluid into the accommodating cavity and discharging the hydraulic fluid in the accommodating cavity.

4. The hydraulic cylinder according to claim 3, wherein a first channel is arranged on the second piston to communicate the accommodating cavity with the tubular piece.

5. The hydraulic cylinder according to claim 3, wherein a first hole is formed in the cavity wall of the first cavity to communicate with the end of the tubular piece away from the second piston, the first hole for inputting the hydraulic fluid into the accommodating cavity and discharging the hydraulic fluid in the accommodating cavity.

6. The hydraulic cylinder according to claim 3, wherein the third cavity is communicated with the end of the tubular piece away from the second piston, the third cavity is configured to introduce or discharge the hydraulic fluid, the first cavity is configured to discharge the fluid when the third cavity introduces the hydraulic fluid to push the piston rod to retract into the cylinder body, and the third cavity is configured to discharge the hydraulic fluid when the first cavity introduces the hydraulic fluid to push the piston rod to extend out of the cylinder body.

7-8. (canceled)

9. The hydraulic cylinder according to claim 1, wherein a second hole is formed in the piston rod to communicate the third cavity with the accommodating cavity.

10. The hydraulic cylinder according to claim 1, wherein a second channel is arranged on the first piston to communicate the accommodating cavity with the third cavity.

11. The hydraulic cylinder according to claim 1, wherein the accommodating cavity is communicated with the first cavity.

12. The hydraulic cylinder according to claim 11, wherein a second through hole is formed in the first piston to communicate the first cavity with the accommodating cavity.

13. A hydraulic system, comprising:
the hydraulic cylinder according to claim 1,
a box body for accommodating the hydraulic fluid discharged by the accommodating cavity and/or the first cavity; and
a pump for pressurizing the hydraulic fluid in the box body and delivering the pressurized hydraulic fluid to the first cavity to push the first piston to move.

14. The hydraulic system according to claim 13, wherein the hydraulic system has a first working state and a second working state,
in the first working state, the first cavity is communicated with the pump to introduce the hydraulic fluid pressurized by the pump, and the accommodating cavity is communicated with the box body to discharge the hydraulic fluid in the accommodating cavity into the box body; and
in the second working state, the first cavity is communicated with the box body to discharge the hydraulic fluid in the first cavity into the box body, and the accommodating cavity is communicated with the pump to introduce the hydraulic fluid pressurized by the pump.

15. A crane, comprising the hydraulic system according to claim 13.

16. The crane according to claim 15, further comprising a boom, wherein the hydraulic cylinder is for driving the boom to rotate.
